(19) United States
(12) Patent Application Publication
(10) Pub. No.: US 2013/0253117 A1
(43) Pub. Date: Sep. 26, 2013

(54) WEAKLY IONIC POLYMERS FOR AN AQUEOUS SUSPENSION OF MINERAL FILLERS FOR PAPER COATING COLORS INTENDED FOR INK JET PRINTING

(71) Applicant: COATEX S.A.S., Genay (FR)

(72) Inventors: Murielle GUILLOT, Albigny Sur Saone (FR); Olivier Guerret, Pern (FR)

(73) Assignee: COATEX S.A.S., Genay (FR)

(21) Appl. No.: 13/834,547

(22) Filed: Mar. 15, 2013

Related U.S. Application Data
(60) Provisional application No. 61/618,017, filed on Mar. 30, 2012.

(30) Foreign Application Priority Data
Mar. 23, 2012 (FR) 12 52633

(51) Int. Cl. C08L 33/10; C08K 3/30; C08K 3/26; C08L 37/00; C08K 3/22; C08L 33/14; C08L 53/00; C08L 33/26; C08K 3/10; C08K 3/34

(52) U.S. Cl. CPC C08L 33/10; C08K 3/10; C08K 3/30; C08K 3/26; C08K 3/34; C08K 3/346; C08K 3/22; C08L 33/14; C08L 53/00; C08L 33/26; C08L 37/00
USPC 524/423; 524/436; 524/401; 524/425; 524/451; 524/447; 524/505; 524/522; 524/517

(57) ABSTRACT

The present invention provides weakly ionic polymeric additives that, when used in aqueous suspensions of commercial mineral fillers (dispersed with an anionic polymer), enable the introduction of organic or mineral salts in significant quantities without causing a destabilization of the medium. The suspension are useful in the formulation of a paper coating color designed for an application of the ink-jet type.

### CROSS REFERENCE TO RELATED APPLICATIONS

This application claims priority to U.S. provisional application Ser. No. 61/618,017, filed Mar. 30, 2012; and to French patent application 12 52633, filed Mar. 23, 2012, the disclosures of which are both incorporated herein by reference.

### BACKGROUND OF THE INVENTION

The present invention concerns weakly ionic polymeric additives that, when used in aqueous suspensions of commercial mineral fillers (dispersed with an anionic polymer) enable the introduction of organic or mineral salts in significant quantities without causing a destabilization of the medium. In a beneficial way, these suspensions that contain a large dose of salt can be used directly in the formulation of a paper coating color designed for an application of the ink-jet type.

Ink jet printing technology is used in printing on paper support by means of ink droplets. Using different mechanical means, these droplets are ejected or propelled onto the paper support on which they form dots that create the corresponding text or image.

The intrinsic qualities of this technology explain its rapid development: a possibility of high-speed printing without contact and without impact, with a high definition, thus giving access to quality colour images. Independently, the progress made in electronics and computer science contributes to a continuous improvement in computers and photo digital equipment. This evolution in equipment, coupled with the low purchase price of inkjet printers, leads more and more users to this printing technology. Today, this technology is used both by professionals and the general public alike for printing objects as diverse as letters, reports, brochures, magazines, postcards, digital photographs, labels, posters, etc.

At the present time, it is considered that there are 2 types of substrates for ink jet application: “ordinary” papers and “special” papers. The first are used for low to average quality printing at lower cost. The second are recommended when a high rendering of the image or text to be printed is expected, and is obtained at a higher cost. The major difference between these 2 categories lies in the application of an aqueous-based coating to the support surface in the case of the specialty papers.

This coating is called a “paper coating color”: It is an aqueous formulation conventionally containing water, at least one mineral filler, one or more binders as well as various additives. In paper coating colors for inkjet type printing, mineral or organic salts are also included to set the ink when it contacts the surface of the paper in the form of ink jet droplets. Documents WO 2009/110910, WO 2010/068193 and WO 2011/008218 give examples of such formulations for ink-jet technology. These mineral or organic salts are usually present in the paper coatings color in significant quantities, for example between 1 and 15% by weight of the formulation. The mineral or organic salts of the suspension must be available to set the ink droplets at the moment the droplet reaches the surface of the paper.

The mineral filler included in the paper coating color is conveyed in the form of an aqueous suspension. Conventionally, this filler is a synthetic or natural material, optionally modified which is suspended in water by a dispersant. The most common dispersants include anionic polymers of low molecular weight (less than 10,000 g/mol) that are homopolymers of acrylic acid, such as described in: FR 2 488 814, FR 2 603 042, EP 0 100 947, EP 0 100 948, EP 0 129 329, EP 0 542 643 and EP 0 542 644.

Today, a requirement of mineral material manufacturers is to introduce into anionic aqueous suspensions of mineral fillers the organic or mineral salt or salts that are necessary in the final formulation of the paper coating color. In this way, the work of the paper coating formulator would be simplified by the elimination of a compound to be introduced.

On the other hand, this step of introducing a salt into the paper coating color may cause a destabilization of the paper coating color. Aqueous suspensions of commercial mineral fillers (classically dispersed with a low molecular weight anionic polymer) also very poorly support the introduction of salt. The state of dispersion of the medium is no longer homogeneous, resulting in a dramatic increase in its viscosity. The suspension is no longer sufficiently fluid to be transported, decanted or pumped. Its stability can be affected, which prohibits any storage, even of short duration.

Also, there is an unresolved technical problem related to the destabilization of aqueous suspensions of mineral fillers dispersed in an anionic manner when at least one mineral or organic salt is added.

In view of theses technical problems, there is a need for an aqueous suspension of materials containing mineral fillers and a mineral or organic salt. Therefore, an objective of the present invention is to provide a stable aqueous suspension containing mineral fillers and a mineral or organic salt which is suitable for utility in a paper coating color.

### SUMMARY OF THE INVENTION

This and other objectives have been achieved by the preset invention the first embodiment of which includes a method to prepare an aqueous suspension, the suspension, comprising: a mineral filler; at least one anionic dispersant; and at least one mineral or organic salt; the method, comprising:

adding at least one water-soluble polymer obtained by copolymerization of

a) 5% to 40% based on total weight of the polymer of (meth)acrylic acid, and

b) 60% to 95% based on total weight of the polymer of at least one monomer of formula (I):

R-(EO)ₘ—(PO)ₙ—R′ (I)

wherein

R is a polymerizable group selected from the group consisting methacrylate and methacrylurethane groups,

EO and PO respectively are ethylene-oxy and propylene-oxy units, which are in block, alternating or random order,

m and n are integers, at least one of which is non-zero and are between 0 and 100,

R′ is hydrogen or an alkyl group with from 1 to 4 carbon atoms.

In another embodiment, the present invention provides an aqueous suspension, comprising: at least one mineral filler, an anionic dispersant, at least one mineral or organic salt, and a water-soluble polymer obtained by copolymerization of

a) 5% to 40% relative to a total monomer weight of (meth)acrylic acid, and

b) 60% to 95% relative to the total monomer weight of at least one monomer of formula (I):

R-(EO)ₘ—(PO)ₙ—R′ (I)

wherein

R is a polymerizable group selected from the group consisting methacrylate and methacrylurethane groups,

EO and PO respectively are ethylene-oxy and propylene-oxy units, which are in block, alternating or random order,

m and n are integers, at least one of which is non-zero and are between 0 and 100,

R′ is hydrogen or an alkyl group with from 1 to 4 carbon atoms.

wherein a total solids content of the suspension is from 10 and 80% by weight of the suspension. The aqueous suspension according to the invention is useful for the preparation of a paper coating color.

### DETAILED DESCRIPTION OF THE INVENTION

Throughout the following description, when ranges of vales are described, those ranges include all values and subranges within the numbers listed unless otherwise specified.

The inventors have surprisingly discovered that certain water-soluble polymers when included in aqueous suspensions of mineral fillers enables the addition of mineral or organic salt without leading to destabilization of the suspension.

Thus, in a first embodiment, the present invention includes a method to prepare an aqueous suspension, the suspension, comprising:

a mineral filler;

at least one anionic dispersant; and

at least one mineral or organic salt;

the method, comprising:

adding at least one water-soluble polymer obtained by copolymerization of

a) 5% to 40% based on total weight of the polymer of (meth)acrylic acid, and

b) 60% to 95% based on total weight of the polymer of at least one monomer of formula (I):

R-(EO)ₘ—(PO)ₙ—R′ (I)

wherein

R is a polymerizable group selected from the group consisting methacrylate and methacrylurethane groups,

EO and PO respectively are ethylene-oxy and propylene-oxy units, which are in block, alternating or random order,

m and n are integers, at least one of which is non-zero and are between 0 and 100,

R′ is hydrogen or an alkyl group with from 1 to 4 carbon atoms.

According to the present invention, “compatibilising agent” is defined as an agent that allows the introduction of a mineral or organic salt into an aqueous suspension of a mineral filler containing at least one anionic dispersant without leading to a destabilization of the suspension, that is, without leading to a loss of the homogeneous nature of the suspension and therefore to an increase in viscosity which would render it unusable as a component of a paper coating color. Indeed, the inventors realized that the water soluble polymer according to the present invention makes the simultaneous presence of a salt and an anionic dispersant compatible in the claimed aqueous suspension.

According to the present invention, the terms “polymeric additive” or “polymer additive” may be used in the place of a “water-soluble polymer” with an equivalent meaning. In addition, by “weakly ionic water-soluble polymer” is meant a polymer that is soluble in water and that has a mass ratio which favours the non-ionic monomer of formula (I) at the expense of the anionic monomer (acrylic or methacrylic acid). The weakly ionic character of the polymer according to the present invention is related to the presence of 5 to 40% by weight of (meth)acrylic acid monomers.

According to the present invention, “(meth)acrylic acid” describes the monomers of acrylic acid and/or methacrylic acid. According to one aspect of the present invention, the copolymer includes 5 to 40% of acrylic acid monomers. According to another aspect of the present invention, the copolymer includes 5 to 40% of methacrylic acid monomers. Finally, according to still another aspect of the present invention, the copolymer includes 5 to 40% of an admixture of acrylic acid and methacrylic acid monomers.

According to one embodiment of the present invention, the water-soluble polymer contains between 5 and 25% by weight of (meth)acrylic acid, preferably, between 10 and 15% by weight of (meth)acrylic acid.

According to an another embodiment of the present invention, the water-soluble polymer contains between 75 and 95% by weight of formula I monomers, preferably, between 80% and 90% by weight of formula I monomers.

According to still another embodiment of the present invention, the R group of the formula (I) monomer may be a methacrylate group, and the R′ group of the formula (I) monomer may be hydrogen.

According to one preferred embodiment of the invention, the integers m and n of the formula (I) monomer are such that the ratio m/(m+n) is from 0.5 to 0.95.

According to one embodiment of the present invention, the molecular weight of the formula (I) monomer is from 1,000 g/mol to 6,000 g/mol, preferably from 2,000 g/mol to 3,000 g/mol. For example, the molecular weight of the formula (I) monomer may be 2,000 g/mol or 3,000 g/mol.

According to one embodiment of the present invention, the mineral salt may be from the group consisting of calcium chloride, sodium chloride, potassium chloride, calcium bromide, sodium bromide, potassium bromide, calcium sulfate, sodium sulfate and an admixture of at least two of these salts.

According to another embodiment of the present invention, the aqueous suspension of the mineral filler may be a suspension of calcium carbonate, kaolin, talcum, titanium dioxide or an admixture of at least two of these compounds.

According to another embodiment of the present invention, the anionic dispersant of the initial mineral suspension may be a salt of polyacrylic acid, optionally including other comonomers, which may in particular be selected from among methacrylic acid, acrylamide, an acrylic ester, a methacrylic ester and methacrylic anhydride.

These different ways of carrying out the present invention may be combined with one another.

In a second embodiment, the present invention provides an aqueous suspension, comprising: at least one mineral filler, an anionic dispersant, at least one mineral or organic salt, and a water-soluble polymer obtained by copolymerization of

a) 5% to 40% based on total weight of the polymer of (meth)acrylic acid, and

b) 60% to 95% based on total weight of the polymer of at least one monomer of formula (I):

R-(EO)ₘ—(PO)ₙ—R′ (I)

wherein

R is a polymerizable group selected from the group consisting methacrylate and methacrylurethane groups,

EO and PO respectively are ethylene-oxy and propylene-oxy units, which are in block, alternating or random order,

m and n are integers, at least one of which is non-zero and are between 0 and 100,

R′ is hydrogen or an alkyl group with from 1 to 4 carbon atoms.

wherein a total solids content of the suspension is from 10 and 80% by weight of the suspension.

According to one aspect of the invention, the concentration by weight (or percentage by weight) of water-soluble polymer may be from 10% to 50% by weight of the suspension, preferably from 10 to 30% by weight, most preferably, from 15 to 20% by weight of the suspension.

According to one aspect of the present invention, the mineral salt content of the aqueous solution may be from 10% to 50%, preferably, from 10% to 30%, most preferably, from 15% to 20%.

According to one aspect of the invention, the total solids content of the admixture may be from 20% to 60% by weight, preferably from 25% to 35% by weight.

These different aspects of the present invention can be combined with one another.

Another embodiment of the invention includes an aqueous suspension of mineral fillers for paper coating colors for ink jet printing, with a total solids content between 10% and 80% by weight, including:

at least one mineral filler,

an anionic dispersant,

mineral or organic salts, and
a water-soluble polymer obtained by copolymerization of
a) 5% to 40% based on total weight of the polymer of (meth)acrylic acid, and
b) 60% to 95% based on total weight of the polymer of at least one monomer of formula (I):

R-(EO)ₘ—(PO)ₙ—R′ (I)
wherein
R is a polymerizable group selected from the group consisting methacrylate and methacrylurethane groups,
EO and PO respectively are ethylene-oxy and propylene-oxy units, which are in block, alternating or random order,
m and n are integers, at least one of which is non-zero and are between 0 and 100,
R′ is hydrogen or an alkyl group with from 1 to 4 carbon atoms.

According to one embodiment of the present invention, the water-soluble polymer contains from 5 to 25% by weight of (meth)acrylic acid, preferably from 10 to 15% (meth)acrylic acid.

According an another embodiment of the present invention, the water-soluble polymer contains between 75 and 95% by weight of formula I monomers, for example, between 80% and 90% by weight of formula I monomers.

According to still another embodiment of the present invention, the R group of the formula (I) monomer represents a methacrylate group, and the R′ group of the formula (I) monomer represents hydrogen.

According to one embodiment of the invention, a ratio m/(m+n) of formula (I) may be between 0.5 and 0.95.

According to one embodiment of the present invention, the molecular weight of the formula (I) monomer may be from 1,000 g/mol to 6,000 g/mol, preferably from 2,000 g/mol to 3,000 g/mol. For example, the molecular weight of the formula (I) monomer may be 2,000 g/mol or 3,000 g/mol.

According to one aspect of the present invention, the mineral filler may be selected from the group consisting of calcium carbonate, kaolin, talcum, titanium dioxide and an admixture of at least two of these compounds.

According to one aspect of the invention, the content (or percentage by weight) of water-soluble polymer may be from 10 to 50% by weight relative to the total weight of the suspension, preferably from 10% to 30% by weight, most preferably, from 15 to 20% by weight.

According to another aspect of the present invention, the mineral or organic salt content of the aqueous solution may be from 1% and 15% or between 2% and 12%.

According to still another aspect of the invention, the total solids content of the formulation may be from 20% to 60% by weight, preferably from 25% to 35% by weight.

According to one aspect of the present invention, the mineral salts may be selected from the group consisting of calcium chloride, magnesium chloride, sodium chloride, potassium chloride, calcium bromide, magnesium bromide, sodium bromide, potassium bromide, calcium sulfate, sodium sulfate and an admixture of at least two of these salts.

According to another embodiment of the present invention, the anionic dispersant of the initial mineral suspension is a salt of polyacrylic acid, optionally including other comonomers, which may be selected from the group consisting of methacrylic acid, acrylamide, an acrylic ester, a methacrylic ester and methacrylic anhydride.

These different aspects of the present invention may be combined with one another.

The water-soluble polymer of the present invention may be in the acid or neutralized form.

If it is used in the neutralized form, it can be partially or completely neutralized. A monovalent, divalent or trivalent agent may be used to neutralize the polymer. This agent is for example selected from among the potassium ion, the sodium ion, the lithium ion, the calcium ion, the magnesium ion or an admixture of these ions. This agent may also be a primary, secondary or tertiary amine.

If it is in the acid or partially neutralized form, it may be possible that a part of the mineral or organic salt added to the mineral filler suspension according to the invention binds to the polymer. However, the quantities of mineral salts contained in the aqueous suspensions used in the ink-jet application are such that the proportion of salts used to neutralize the polymer may be negligible.

Such admixtures are new and have the advantage for the paper coating color manufacturer of being able to simultaneously introduce the salt and its compatibiliser into a mineral suspension dispersed by an anionic dispersant.

Having generally described this invention, a further understanding can be obtained by reference to certain specific examples which are provided herein for purposes of illustration only, and are not intended to be limiting unless otherwise specified.

### EXAMPLES

### Example 1

This example describes the use of various polymeric additives for the purpose of trying to make compatible an aqueous suspension of commercial calcium carbonate containing an anionic dispersant, with the addition of a salt.

Water was added to a modified calcium carbonate suspension marketed by the Omya company under the name Omyajet™ 5020, so as to adjust the final solids content, expressed in % by dry weight of the calcium carbonate and salt admixture, to equal to 50% of the total weight of the suspension thus created.

The Omyajet™ 5020 product is an aqueous suspension of calcium carbonate at a 60% mass concentration and classically dispersed in an anionic manner.

For each of the following tests, the viscosity of the admixtures was measured at 25° C. and for admixtures for which the pH was adjusted to 8.5.

### Test No. 1

This test was a non-invention reference (without water-soluble polymer according to the present invention).
For 100 parts by dry weight of calcium carbonate, 10 parts by dry weight of calcium chloride were added directly to the aqueous suspension under moderate agitation.
A very large increase was then observed in the Brookfield™ viscosity at 25° C. and 100 RPM thus equal to 7,000 mPa·s.
Such a viscosity level was incompatible with any handling or storage operation of the suspension.

In each of the tests Nos. 2 to 11 that follow, a polymeric additive was added to the calcium carbonate suspension. For each test, 3 different proportions of the polymeric additive were prepared: 0.8%, 1% and 1.5% by dry weight in relation to the dry weight of calcium carbonate. Ten parts by dry weight of calcium chloride (mineral salt) were then added. The measured viscosity values are given in table 1.

The polymers according to the invention in tests 3 to 11 were obtained using the manufacturing process described in references WO 2001/07494 and WO 2011/154789.

### Test No. 2

A non-invention polymeric additive which is a homopolymer of acrylic acid, totally neutralized by the sodium ion, and with a weight-average molecular weight equal to 6,500 g/mol was used
A solidification of the medium was observed: any measurement of viscosity was impossible.

### Test No. 3

This test illustrated the invention.
The following polymeric additive was used: a polymeric additive which is a copolymer of, expressed in % by weight of each of its monomers:
a) 12.8% of acrylic acid,
b) 87.2% of a monomer with the formula (I) in which R is the methacrylate group, R′ designates hydrogen, n=48, m=16,
   with a weight-average molecular weight equal to 45,000 g/mol, and where 100% of its carboxylic sites were neutralized by the sodium ion.

### Test No. 4

This test illustrated the invention.
The test employed a polymeric additive which was a copolymer of, expressed in % by weight of each of its monomers:
a) 12.8% of acrylic acid,
b) 87.2% of a monomer with the formula (I) in which R is the methacrylate group, R′ designates hydrogen, n=48, m=16,
   with a weight-average molecular weight equal to 130,000 g/mol, and where 100% of its carboxylic sites were neutralized by the sodium ion.

### Test No. 5

This test illustrated the invention.
The test employed a polymeric additive which was a copolymer of, expressed in % by weight of each of its monomers:
a) 7.4% of acrylic acid,
b) 92.6% of a monomer with the formula (I) in which R is the methacrylate group, R′ designates hydrogen, n=48, m=16,
   with a weight-average molecular weight equal to 130,000 g/mol, and where 100% of its carboxylic sites were neutralized by the sodium ion.

### Test No. 6

This test illustrated the invention.
The test employed a polymeric additive which was a copolymer of, expressed in % by weight of each of its monomers:
a) 2.9% of acrylic acid and 19.8% of methacrylic acid
b) 77.3% of a monomer with the formula (I) in which R is the methacrylate group, R′ designates hydrogen, n=48, m=16,
   with a weight-average molecular weight equal to 39,000 g/mol, and where 100% of its carboxylic sites were neutralized by the sodium ion.

### Test No. 7

This test illustrated the invention.
The test employed a polymeric additive which was a copolymer of, expressed in % by weight of each of its monomers:
a) 12.5% of methacrylic acid,
b) 87.5% of a monomer with the formula (I) in which R is the methacrylate group, R′ designates hydrogen, n=48, m=16,
   with a weight-average molecular weight equal to 74,000 g/mol, and where 100% of its carboxylic sites were neutralized by the sodium ion.

### Test No. 8

This test illustrated the invention.
The test employed a polymeric additive which is a copolymer of, expressed in % by weight of each of its monomers:
a) 6% of acrylic acid and 1.8% of methacrylic acid,
b) 92.2% of a monomer with the formula (I) in which R is the methacrylate group, R′ designates the methyl group, n=0, m=113,
   with a weight-average molecular weight equal to 32,500 g/mol, and where 100% of its carboxylic sites were neutralized by the sodium ion.

### Test No. 9

This test illustrated the invention.
The test employed a polymeric additive which is a copolymer of, expressed in % by weight of each of its monomers:
a) 6% of acrylic acid and 1.8% of methacrylic acid,
b) 92.2% of a monomer with the formula (I) in which R is the methacrylate group, R′ designates the methyl group, n=0, m=113,
   with a weight-average molecular weight equal to 5,000,000 g/mol, and where 100% of its carboxylic sites were neutralized by the sodium ion.

### Test No. 10

This test illustrated the invention.
The test employed a polymeric additive which is a copolymer of, expressed in % by weight of each of its monomers:
a) 8% of acrylic acid and 2.5% of methacrylic acid,
b) 89.5% of a monomer with the formula (I) in which R is the methacrylate group, R′ designates the methyl group, n=0, m=113,
   with a weight-average molecular weight equal to 1,800,000 g/mol, and where 50% of its carboxylic sites were neutralized by the sodium ion, the other part remaining acid.

### Test No. 11

This test illustrated the invention.
The test employed a polymeric additive which is a copolymer of, expressed in % by weight of each of its monomers:
a) 8% of acrylic acid and 2.5% of methacrylic acid,
b) 89.5% of a monomer with the formula (I) in which R is the methacrylate group, R′ designates the methyl group, n=0, m=113,
   with a weight-average molecular weight equal to 3,000,000 g/mol, and where 100% of its carboxylic sites were neutralized by the sodium ion.

For tests No. 4 to 11, which alone resulted in a suspension without solidification (in addition to the reference), the value of its Brookfield™ viscosity at 25° C. and 100 RPM was determined for the suspension. This measurement was made on each of the 3 polymeric additive doses used. The results are shown in table 1.

TABLE 1

| | |
|---|---|
| REFerence | dose (%)* |

| Test No. | INvention | 0 | 0.8 | 1 | 1.5 |
|---|---|---|---|---|---|
| 1 | REF | 7000 | — | — | — |
| 3 | IN | — | 1140 | 760 | 645 |
| 4 | IN | — | 1800 | 1230 | 1150 |
| 5 | IN | — | 2820 | 2880 | 1480 |
| 6 | IN | — | 1375 | 1090 | 825 |
| 7 | IN | — | 2010 | 1765 | 1980 |
| 8 | IN | — | 1220 | 810 | 650 |
| 9 | IN | — | 2290 | 1200 | 1065 |
| 10 | IN | — | 2960 | 2040 | 1370 |
| 11 | IN | — | 3290 | 2100 | 1275 |

*dose (%): % in dry % of polymer used in relation to the dry weight of calcium carbonate

The data of Table 1 shows that the polymers according to the invention allow a favourable reduction in the viscosity of suspensions containing calcium chloride.

Such suspensions, both stable and handleable, may be used directly to formulate paper coating colors for ink jet type applications. The use of a water-soluble polymer according to the invention enabled the preparation, without destabilization, of an aqueous suspension containing particles of mineral substance dispersed by an anionic dispersant and containing calcium chloride in the same suspension.

### Example 2

This example was directed to the use of various polymeric additives for the purpose of trying to make compatible a commercial calcium carbonate, containing a sodium polyacrylate, with the addition of a salt.

According to the test, water was added to a suspension of 78% solid content calcium carbonate which was obtained by grinding, in the presence of a neutralized acrylic polyacid, 90% of the particles of which have a diameter less than 2 μm and a median diameter of 0.8 μm, in order to adjust the final solids content, expressed in % dry weight of the calcium carbonate and salt admixture, to equal 60% of the total weight of the suspension thus realised.

For each of the following tests, the viscosity of the admixtures was taken at 25° C. and for admixtures whose pH was adjusted to 8.5.

### Test No. 12

This test corresponded to a reference (without water-soluble polymer according to the present invention).
For 100 parts by dry weight of calcium carbonate, 10 parts by dry weight of calcium chloride were added directly under moderate agitation.
A very large increase was observed in the Brookfield™ viscosity at 25° C. and 100 RPM, thus equal to 2,230 mPa·s.
In tests No. 13 to 15, a polymeric additive was first added, and then 10 parts by dry weight of calcium chloride.

### Test No. 13

The test employed 0.8% by dry weight, in relation to the dry weight of calcium carbonate, of a non-invention polymeric additive which was a homopolymer of acrylic acid, totally neutralized by the sodium ion, and with a weight-average molecular weight equal to 6,500 g/mol.
The Brookfield™ viscosity at 25° C. and 100 RPM of the suspension increased relative to the reference, since it was equal to 4,260 mPa·s. This clearly demonstrated the ineffectiveness of polymer tested.

### Test No. 14

This test illustrated the invention.
The test employed 0.8% by dry weight, relative to the dry weight of calcium carbonate, of a polymeric additive which was a copolymer of, expressed in % by weight of each of its monomers:
a) 12.8% of acrylic acid,
b) 87.2% of a monomer with the formula (I) in which R is the methacrylate group, R′ designates hydrogen, n=48, m=16,
   with a weight-average molecular weight equal to 45,000 g/mol, and where 100% of its carboxylic sites were neutralized by the sodium ion.
   The Brookfield™ viscosity at 25° C. and 100 RPM of the suspension then decreased significantly relative to the reference, since it was equal to 450 mPa·s. This clearly demonstrated the ability of the polymer tested to make this anionic aqueous suspension of calcium carbonate compatible with the addition of a salt. Such a suspension may advantageously be used directly to make a paper coating color for ink jet type printing.

### Test No. 15

This test illustrated the invention: preparation of an admixture of a polymer (I) and calcium chloride.
In 1 litre of demineralised water, the test employed 200 g by dry weight of a polymeric additive which was a copolymer of, expressed in % by weight of each of its monomers:
a) 12.8% of acrylic acid,
b) 87.2% of a monomer with the formula (I) in which R is the methacrylate group, R′ designates hydrogen, n=48, m=16,
   and 150 g of calcium chloride. The admixture was agitated for 5 minutes at room temperature. Neither cloudiness nor an increase in viscosity was observed, indicating perfect compatibility of the polymer with calcium chloride.
   The same experiment was conducted with sodium chloride and magnesium chloride, and the same results were observed, that is, a homogeneous admixture indicating perfect compatibility of the polymer with these salts.

1. A method to prepare an aqueous suspension, the suspension, comprising:
a mineral filler;
at least one anionic dispersant; and
at least one mineral or organic salt;
the method, comprising:
adding at least one water-soluble polymer obtained by copolymerization of
a) 5% to 40% based on total weight of the polymer of (meth)acrylic acid, and
b) 60% to 95% based on total weight of the polymer of at least one monomer of formula (I):
R-(EO)ₘ—(PO)ₙ—R′ (I)
wherein
R is a polymerizable group selected from the group consisting methacrylate and methacrylurethane groups,
EO and PO respectively are ethylene-oxy and propylene-oxy units, which are in block, alternating or random order,
m and n are integers, at least one of which is non-zero and are between 0 and 100,
R′ is hydrogen or an alkyl group with from 1 to 4 carbon atoms.

2. The method according to claim 1, wherein the % by weight of the (meth)acrylic acid in the water-soluble polymer is from 5 to 25%.

3. The method according to claim 1, wherein the % by weight of the (meth)acrylic acid in the water-soluble polymer is from 10 to 15%.

4. The method according to claim 1, wherein R is a methacrylate group and R′ is hydrogen.

5. The method according to claim 1, wherein a ratio m/(m+n) of formula (I) is from 0.5 to 0.95.

6. The method according to claim 1, wherein a molecular weight of the monomer of formula (I) is from 1,000 g/mol to 6,000 g/mol.

7. The method according to claim 1, wherein the mineral salt is at least one selected from the group consisting of calcium chloride, magnesium chloride, sodium chloride, potassium chloride, calcium bromide, magnesium bromide, sodium bromide, potassium bromide, calcium sulfate, sodium sulphate.

8. The method according to claim 1, wherein the mineral filler is at least one selected from the group consisting of calcium carbonate, modified calcium carbonate, kaolin, talcum, and titanium dioxide.

9. The method according to claim 1, wherein the anionic dispersant is a salt of polyacrylic acid which comprises a copolymerized monomer selected from the group consisting of methacrylic acid, acrylamide, an acrylic ester, a methacrylic ester and methacrylic anhydride.

10. An aqueous suspension, comprising:
at least one mineral filler,
an anionic dispersant,
at least one mineral or organic salt, and
water-soluble polymer obtained by copolymerization of
a) 5% to 40% based on total weight of the polymer of (meth)acrylic acid, and
b) 60% to 95% based on total weight of the polymer of at least one monomer of formula (I):
R-(EO)ₘ—(PO)ₙ—R′ (I)
wherein
R is a polymerizable group selected from the group consisting methacrylate and methacrylurethane groups,
EO and PO respectively are ethylene-oxy and propylene-oxy units, which are in block, alternating or random order,
m and n are integers, at least one of which is non-zero and are between 0 and 100,
R′ is hydrogen or an alkyl group with from 1 to 4 carbon atoms,
wherein a total solids content of the suspension is from 10 and 80% by weight of the suspension.

11. The aqueous suspension according to claim 10 wherein the solids content is from 20% to 60% by weight.

12. The aqueous suspension according to claim 10 wherein a content of the water-soluble polymer is from 10 to 50% by weight of the suspension.

13. The aqueous suspension according to claim 10 wherein a content of the at least one mineral or organic salt is from 1 to 15%.

14. The aqueous suspension according to claim 10 wherein the said water-soluble polymer is partially neutralized or completely neutralized.

15. The aqueous suspension according to claim 10 wherein the anionic dispersant is a salt of polyacrylic acid which comprises a copolymerized monomer selected from the group consisting of methacrylic acid, acrylamide, an acrylic ester, a methacrylic ester and methacrylic anhydride.

16. A paper coating color comprising the aqueous suspension according to claim 10 and at least one binder.
